(19) United States
(12) Patent Application Publication
(10) Pub. No.: US 2004/0092652 A1
(43) Pub. Date: May 13, 2004

(54) Water-soluble acrylic binder, method for producing the same, ceramic slurry composition, method for producing the same, monolithic ceramic electronic part and method for manufacturing the same

(76) Inventors: Masachika Takata, Toyama-shi (JP); Masaru Kodou, Omihachiman-shi (JP); Makoto Miyazaki, Hirakata-shi (JP); Satoru Tanaka, Moriyama-shi (JP)

Correspondence Address: DICKSTEIN SHAPIRO MORIN & OSHINSKY LLP, Edward A. Meilman, 41st Floor, 1177 Avenue of the Americas, New York, NY, 10036-2714, US

(21) Appl. No.: 10/703,468

(22) Filed: Nov. 10, 2003

(30) Foreign Application Priority Data
Nov. 8, 2002 (JP) 2002-324798
Jul. 25, 2003 (JP) 2003-201773
Sep. 10, 2003 (JP) 2003-317882

(51) Int. Cl. C08K 3/00

(52) U.S. Cl. 524/556

(57) ABSTRACT

A ceramic slurry composition contains a mixture of a ceramic raw material powder, a water-soluble acrylic binder and water. A resin component of the water-soluble acrylic binder has a weightaverage molecular weight of about 10,000 to 500,000 and an inertial square radius in water of about 100 nm or less, and the alcohol content of the water-soluble acrylic binder is about 5% by weight or less when the resin content is 40% by weight. The pH of the ceramic slurry composition is preferably controlled to about 8.5 to 10

### BACKGROUND OF THE INVENTION

1. Field of the Invention

The present invention relates to a water-soluble acrylic binder used for producing a ceramic green sheet and a method for producing the binder, a ceramic slurry composition containing the water-soluble acrylic binder and a preferred method for producing the composition, a monolithic ceramic electronic part manufactured by using the ceramic slurry composition and a method for manufacturing the electronic part. Particularly, the present invention relates to an improvement of a water-soluble acrylic binder used for forming slurry of a ceramic raw material powder.

2. Description of the Related Art

The number of types of monolithic ceramic electronic parts such as monolithic ceramic capacitors and the production quantity thereof are increasing with requirements for an electronic part having a smaller size and higher density and being lightweight. Such a monolithic ceramic electronic part is manufactured by a manufacturing method comprising forming an internal conductor film as an electrode on each of a plurality of ceramic green sheets, stacking and compacting the ceramic green sheets to obtain a green laminate, and then burning the laminate to simultaneously sinter a ceramic component contained in the ceramic green sheets and a conductive component contained in the internal conductor films.

The ceramic green sheets used for manufacturing the monolithic ceramic electronic part are usually required to be further thinned. In some cases, the ceramic green sheets are required to be thickened. In any case, it is important for the ceramic green sheets to have a small variation in thickness and no pores, and contain a ceramic raw material powder with excellent dispersibility. From this viewpoint, it is advantageous to mold the granulated ceramic raw material powder into a ceramic green sheet by a wet molding method rather than a dry press molding method.

In the sheet molding method, a ceramic slurry containing the ceramic raw material powder is prepared. The ceramic slurry is conventionally produced by using polyvinyl butyral or the like as a binder, and an organic solvent such as an alcohol, an aromatic solvent or the like, as a solvent (refer to, for example, Japanese Unexamined Patent Application Publication No. 11-348015).

This method thus has the safety and health problem of necessitating an explosion-proof apparatus and process materials deteriorating the working environment. Therefore, a countermeasure against this safety and health problem is required, causing the problem of increasing the production cost of the ceramic green sheets.

In order to solve the problem, the use a water-soluble acrylic binder has been proposed. The water-soluble acrylic binder is a solution binder containing a resin component and a solvent, and particularly, a water-soluble acrylic binder containing a hydrophobic component as a main component of the resin component is easily adsorbed on a ceramic raw material powder containing a hydrophobic component, thereby forming an ideal dispersion system having excellent dispersibility. Also, the resulting ceramic green sheets absorb little moisture and thus have the advantage of small deterioration due to atmospheric humidity. Furthermore, the strength and elongation percentage of the resulting sheets are equivalent to those of sheets formed by using an organic binder such as polyvinyl butyral or the like (refer to, for example, Japanese Unexamined Patent Application Publication No. 11-268959).

However, the conventional water-soluble acrylic binder containing the hydrophobic component as the main component of the resin component has high solution viscosity and thus contributes high viscosity when used for slurry. Therefore, the fluidity of the slurry is decreased, and the dispersibility also deteriorates, thereby causing difficulties in obtaining homogeneous ceramic green sheets.

A method for solving the problem has been proposed in which the amount of the water added is decreased or the molecular weight of the resin component contained in the binder is decreased to decrease solution viscosity, thereby decreasing the viscosity of slurry.

However, when a ceramic green sheet having a thickness of 60 μm or more is formed in the above-described method, for example, the drying property of the sheet deteriorates due to the increased amount of the water added, thereby causing cracks in the ceramic green sheet. Also, the method has the problem of deteriorating the mechanical properties of the ceramic green sheet such as the tensile strength, elongation percentage, etc. due to the decreased molecular weight of the resin component.

### SUMMARY OF THE INVENTION

Accordingly, it is an object of the present invention to provide a water-soluble acrylic binder capable of solving the above problems and a method for producing the binder, a ceramic slurry composition containing the water-soluble acrylic binder and a preferred method for producing the slurry composition, and a monolithic ceramic electronic part manufactured by using the ceramic slurry composition and a method for manufacturing the electronic part.

In order to solve the above technical problems, a water-soluble acrylic binder of the present invention comprises a resin component and a solvent, wherein the resin component has a weightaverage molecular weight of about 10,000 to 500,000 and an inertial square radius in water of about 100 nm or less, and the alcohol content of the water-soluble acrylic binder is about 5% by weight or less when the resin content is 40% by weight.

The water-soluble acrylic binder permits a decrease in solution viscosity without a decrease in the molecular weight of the resin component used as a hydrophobic component. Therefore, when the water-soluble acrylic binder is mixed with a ceramic raw material powder and water to produce a ceramic slurry composition, the viscosity of the slurry composition can be decreased. Also, the slurry has high dispersibility and fluidity, and thus has excellent moldability for forming a ceramic green sheet, thereby producing a ceramic green sheet with a high density and an excellent drying property.

The resin component of the water-soluble acrylic binder of the present invention is preferably produced by copolymerizing an alkyl acrylate and/or alkyl methacrylate, which is insoluble in water in the state of a homopolymer at normal temperature under normal pressure, with at least one carboxylic acid-containing unsaturated monomer at a ratio of about 93 to 99% by weight of the acrylate and/or methacrylate to about 1 to 7% by weight of the unsaturated monomer. The resin component preferably has a weightaverage molecular weight of about 10,000 to 500,000, and the alcohol content of the water-soluble acrylic binder is preferably about 5% by weight or less when the resin content is 40% by weight.

The water-soluble acrylic binder of the present invention preferably has a pH of about 7 to 9.

The present invention also provides a ceramic slurry composition comprising a mixture of the above described water-soluble acrylic binder of the present invention, a ceramic raw material powder and water.

The ceramic slurry composition of the present invention preferably contains the water-soluble acrylic binder having a solution viscosity of about 50 to 50,000 mPa·s when the resin content of the water-soluble acrylic binder is 40% by weight.

The ceramic slurry composition of the present invention preferably has a pH of 8.5 to 10.

The present invention also provides a monolithic ceramic electronic part manufactured by using the ceramic slurry composition of the present invention.

The present invention further provides a preferred method for producing a water-soluble acrylic binder.

The method for producing the water-soluble acrylic binder of the present invention comprises producing the resin component contained in the water-soluble acrylic binder by copolymerizing an alkyl acrylate and/or alkyl methacrylate, which is insoluble in water in the state of a homopolymer at normal temperature under normal pressure, with at least one carboxylic acid-containing unsaturated monomer at a ratio of about 93 to 99% by weight of the acrylate and/or methacrylate to about 1 to 7% by weight of the unsaturated monomer. The method comprises the following steps.

In a first step, an alkyl acrylate and/or alkyl methacrylate and a carboxylic acid-containing unsaturated monomer are added to a solution containing an alcohol and water to form a mixed solution containing the resin component produced by copolymerization of the alkyl acrylate and/or alkyl methacrylate and carboxylic acid-containing unsaturated monomer.

In a second step, water is further added to the mixed solution to produce a water-added solution.

In a third step, the water-added solution is concentrated in such a manner that water is added to the water-added solution when the resin content X (% by weight) is 25≦X≦35 during the course of concentration, and then the solution is again concentrated to establish the relationship Y≦190e^{-0.09X} (wherein Y is the alcohol content (% by weight) of the water-added solution, and X satisfies 25≦X≦35), thereby producing the water-soluble acrylic binder containing the resin component.

The amount C (g) of the water added in the third step preferably satisfies the relationship 190e^{-0.09X}/100+0.033≧(A+B/100)/(A+C) (wherein A is the total amount (g) of the water-added solution at the time of the addition of water, and B is the measured alcohol content (% by weight) of the water-added solution at the time of the addition of water).

In the third step, the water-soluble acrylic binder containing the resin component is preferably controlled to a pH of about 7 to 9.

The present invention further provides a method for producing a ceramic slurry composition. The method for producing the ceramic slurry composition of the present invention comprises a step of mixing the water-soluble acrylic binder produced by the producing method of the present invention, a ceramic raw material powder, and water.

In the step of producing the ceramic slurry composition, the ceramic slurry composition is preferably controlled to a pH of about 8.5 to 10.

The present invention further provides a method for manufacturing a monolithic ceramic electronic part using a ceramic slurry composition produced by the above-described producing method. The method for manufacturing the monolithic ceramic electronic part of the present invention comprises the steps of preparing ceramic green sheets using the ceramic slurry composition, forming a conductor film on each of the ceramic green sheets, stacking and compacting the ceramic green sheets to produce a ceramic laminate, and burning the ceramic laminate.

Examples of monolithic ceramic electronic parts to which the present invention is applied include a monolithic ceramic capacitor, a monolithic ceramic inductor, a monolithic ceramic composite part, a multilayer ceramic substrate, and the like.

In the water-soluble acrylic binder of the present invention, the resin component has a weightaverage molecular weight of about 10,000 to 500,000 and an inertial square radius in water of about 100 nm or less, and the alcohol content of the water-soluble acrylic binder is about 5% by weight or less when the resin content is 40% by weight. Therefore, the solution viscosity of the water-soluble acrylic binder can be decreased, thereby decreasing the viscosity of the ceramic slurry composition prepared by using the water-soluble acrylic binder.

Therefore, deterioration in the molding density, tensile strength and elongation percentage of the ceramic green sheet formed by using the ceramic slurry composition can be prevented, and the amount of the water added for controlling the viscosity of the ceramic slurry composition to the same as a conventional viscosity can be decreased, thereby shortening the drying time of the ceramic green sheet.

Thus, whether the ceramic green sheet is thin or thick, a high-quality monolithic ceramic electronic part such as a monolithic ceramic capacitor can be manufactured by using the ceramic green sheet.

In the ceramic slurry composition of the present invention, the solution viscosity of the water-soluble acrylic binder is about 50 to 50,000 mPa·s when the resin content of the water-soluble acrylic binder is 40% by weight, so that the slurry viscosity can be securely decreased to improve the moldability of a thick sheet of, for example, about 60 μm or more in thickness.

In the method for producing the water-soluble acrylic binder of the present invention, water is further added to the mixed solution containing an alcohol, water and the predetermined resin component to produce the water-added solution, and the water-added solution is concentrated in such a manner that water is added to the water-added solution when the resin content X (% by weight)of the water-added solution is 25≦X≦35 during the course of concentration, and then the solution is again concentrated to establish the relationship Y≦190e^{-0.09X} (wherein Y is the alcohol content (% by weight) of the water-added solution, and X satisfies 25≦X≦35), thereby producing the water-soluble acrylic binder containing the resin component. Therefore, the water-soluble acrylic binder of the present invention can be efficiently and securely produced.

In the method for producing the water-soluble acrylic binder of the present invention, the amount C (g) of the water added during the course of concentration preferably satisfies the relationship 190e^{-0.09X}/100+0.033≧(A+B/100)/(A+C) (wherein A is the total amount(g) of the water-added solution at the time of the addition of water, and B is the measured alcohol content (% by weight) of the water-added solution at the time of the addition of water). In this case, a state satisfying Y≦190e^{-0.09X} can be securely obtained.

Furthermore, when the ceramic slurry composition of the present invention is controlled to a pH of 8.5 to 10, the viscosity of the ceramic slurry composition can be decreased, and a change in viscosity with passage of time can be suppressed.

As described above, the water-soluble acrylic binder containing the resin component is controlled to a pH of about 7 to 9 in the step of concentrating the water-added solution to produce the water-soluble acrylic binder containing the resin component in the method for producing the water-soluble acrylic binder of the present invention, and the ceramic slurry composition prepared by using the water-soluble acrylic binder having this pH is controlled to a pH of about 8.5 to 10. In this case, the solution viscosity of the water-soluble acrylic binder is not extremely increased, and thus the ceramic slurry composition having a pH of about 8.5 to 10 can be securely produced.

### BRIEF DESCRIPTION OF THE DRAWINGS

FIG. 1 is a graph showing the relationship between the resin content X and alcohol content Y when the same resin content as that before the addition of water was obtained by re-concentration after the addition of water in the step of adding water to a mixed solution containing a resin component for a water-soluble acrylic binder to form a water-added solution and then concentrating the water-added solution in such a manner that water was added during the course of concentration, and then concentration was again performed to obtain each sample in an experimental example; and

FIG. 2 is a sectional view schematically showing a monolithic ceramic capacitor as a monolithic ceramic electronic part formed in Example 3.

### DESCRIPTION OF THE PREFERRED EMBODIMENTS

A ceramic slurry composition of the present invention is produced by mixing a ceramic raw material powder, a water-soluble acrylic binder and water. The water-soluble acrylic binder contains a resin component and a solvent. The resin component has a weightaverage molecular weight (GPC measured weightaverage molecular weight: abbreviated to “Mw”) of about 10,000 to 500,000, and an inertial square radius in water of about 100 nm or less. When the resin content of the water-soluble acrylic binder is 40% by weight, the alcohol content of the water-soluble acrylic binder is about 5% by weight or less.

The viscosity of a general solution resin decreases as the molecular weight decreases. However, the viscosity can be decreased in the present invention without a decrease in the molecular weight of the resin component contained in the water-soluble acrylic binder.

The reason for controlling the weightaverage molecular weight of the resin component of the water-soluble acrylic binder to about 10,000 to 500,000 as described above is that when the weightaverage molecular weight of less than about 10,000, the binder has low cohesive force which weakens the strength of a ceramic green sheet, while with the weightaverage molecular weight of over about 500,000, the solution viscosity of the binder and the viscosity of a slurry composition are increased.

The reason for controlling the inertial square radius in water of the resin component contained in the water-soluble acrylic binder to about 100 nm or less as described above is that with the inertial square radius of over about 100 nm, the solution viscosity of the binder and the viscosity of a slurry composition are increased.

The reason for controlling the alcohol content of the water-soluble acrylic binder to about 5% by weight or less when the resin content is 40% by weight is the following. It is found that the molecules of the resin component contained in the water-soluble acrylic binder are more easily dissolved in a solvent as the alcohol content of the solvent increases and thus, intermolecular interaction increases to further increase the viscosity. Therefore, as described above, when the alcohol content is about 5% by weight or less, the viscosity can be further decreased to obtain a slurry composition having excellent moldability.

Although the alcohol content is defined on the assumption that the resin content of the water-soluble acrylic binder is 40% by weight, a resin content of about 40% by weight is found to be advantageous for moldability of the slurry composition. In the use of binders the limit of the resin content is conventionally 30% by weight, and with a higher resin content, the viscosity of the binder becomes excessively high. Therefore, the viscosity of the slurry composition also becomes excessively high, thereby causing the problem of deteriorating the dispersibility of the slurry composition.

However, even when the resin content of the water-soluble acrylic binder in the present invention is as high as 40% by weight, the viscosity can be decreased. Thus, even when the amount of the water added to the slurry composition is increased, as compared with a conventional slurry composition, the viscosity of the slurry composition is not high, and the dispersibility of the slurry composition is not impaired. Therefore, the same sheet moldability as that when using of a polyvinyl acetate binder having excellent sheet moldability can be realized.

When the resin content of the water-soluble acrylic binder is 40% by weight, the solution viscosity of the water-soluble acrylic binder is preferably about 50 to 50,000 mPa·s in the ceramic slurry composition of the present invention.

With a solution viscosity of less than about 50 mPa·s, the heating temperature necessary for obtaining such a viscosity is excessively high, thereby causing deterioration of the binder. On the other hand, the resulting slurry composition has low dispersibility with the solution viscosity of over about 50,000 mPa·s due to the excessively high viscosity, thereby causing a decrease in the density of a molded sheet.

The water-soluble acrylic binder contained in the ceramic slurry composition of the present invention can be produced by any known polymerization method, preferably a solution polymerization method or the like, as long as the above conditions are satisfied.

The resin component contained in the water-soluble acrylic binder is preferably a reactive monomer copolymer comprising about 93 to 99% by weight of an alkyl acrylate and/or alkyl methacrylate, which is insoluble in water in the state of a homopolymer at normal temperature under normal pressure, and about 1 to 7% by weight of a carboxylic acid-containing unsaturated monomer.

When a resin component obtained by copolymerizing about 93 to 99% by weight of an alkyl acrylate and/or alkyl methacrylate, which is insoluble in water in the state of a homopolymer at normal temperature under normal pressure, with about 1 to 7% by weight of a carboxylic acid-containing unsaturated monomer, as described above, is used as the resin component contained in the water-soluble acrylic binder, the water-soluble acrylic binder is preferably produced by the following method.

First, an alkyl acrylate and/or alkyl methacrylate and a carboxylic acid-containing unsaturated monomer are added to a solution containing an alcohol and water to form a mixed solution. In this step, polymerization of the alkyl acrylate and/or alkyl methacrylate and the carboxylic acid-containing unsaturated monomer proceeds to produce a resin component. Therefore, the mixed solution contains the resin component.

Next, water is added to the mixed solution to obtain a water-added solution containing the resin component.

Then, the water-added solution is concentrated in such a manner that water is added to the water-added solution when the resin content X (% by weight) is 25≦X≦35 during the course of concentration, and then the solution is again concentrated to establish the relationship Y≦190e^{-0.09X} (wherein Y is the alcohol content (% by weight) of the water-added solution, and X satisfies 25≦X≦35), thereby producing the water-soluble acrylic binder containing the resin component.

In order to obtain the ceramic slurry composition using the water-soluble acrylic binder containing the resin component, the water-soluble acrylic binder, a ceramic raw material powder and water are mixed.

The amount C (g) of the water added in the step of producing the water-soluble acrylic binder containing the resin component preferably satisfies the relationship 190e^{-0.09X}/100+0.033≧(A+B/100)/(A+C) (wherein A is the total amount (g) of the water-added solution at the time of the addition of water, and B is the measured alcohol content (% by weight) of the water-added solution at the time of the addition of water).

In the step of producing the water-soluble acrylic binder containing the resin component, the concentration operation can be performed by, for example, at least one of heating distillation and reduced-pressure distillation.

Although heating distillation may be performed under reduced pressure, atmospheric pressure and high pressure, the heating distillation is normally performed under a pressure of about 0.101 MPa or less. Although the temperature of heating distillation depends upon the pressure of heating distillation, the temperature is normally set to about 40 to 90° C. A heating temperature higher than this range is undesirable because the water-soluble acrylic binder possibly undergoes thermal deterioration.

As a distillation system, simple distillation used for ordinary distillation operations or rectification using a packed column may be used.

As a carrier gas used for distillation, an inert gas such as nitrogen or the like may be used. However, air can also be used without a problem.

In the step of mixing the water-soluble acrylic binder containing the resin component, the ceramic raw material powder and water to produce the ceramic slurry composition, the resulting ceramic slurry composition is preferably controlled to a pH of about 8.5 to 10. As a result, the viscosity of the ceramic slurry composition can be decreased, and a change in viscosity with passage of time can be suppressed.

In order to produce the ceramic slurry composition having a pH of about 8.5 to 10, the water-soluble acrylic binder containing the resin component is controlled to a pH of about 7 to 9 in the step of producing the water-soluble acrylic binder containing the resin component, and then the ceramic slurry composition produced by using the water-soluble acrylic binder having such pH is controlled to a pH of about 8.5 to 10. Therefore, such a pH controlling step is performed according to demand. With pH higher than a desired range, ammonia water can be added, while with pH lower than a desired range, acetic acid can be added for controlling pH.

In the above-described preferred embodiment, a final object is to control the pH of the ceramic slurry composition to about 8.5 to 10. However, if the pH of the water-soluble acrylic binder containing the resin component is not controlled to about 7 to 9, the solution viscosity of the water-soluble acrylic binder is extremely increased, and thus the pH of the ceramic slurry composition produced by using the binder cannot be controlled to decrease the viscosity and suppress a change in the viscosity with passage of time.

Also, even when the ceramic slurry composition is produced by using the water-soluble acrylic binder containing the resin content and having a pH of about 7 to 9, the pH of the ceramic slurry composition is not necessarily about 8.5 to 10 due to the metal ions eluted from the ceramic raw material powder and the influence of the solvent used. Therefore, the pH of each of the water-soluble acrylic binder containing the resin component, and the ceramic slurry composition is preferably controlled.

In the method for producing the water-soluble acrylic binder, each of the alkyl acrylate and alkyl methacrylate used preferably has an alkyl group with 10 to about 8 carbon atoms.

For example, at least one selected from methyl acrylate, ethyl acrylate isopropyl acrylate, n-butyl acrylate, isobutyl acrylate, cyclohexyl acrylate, and 2-ethylhexyl acrylate is favorably used as the alkyl acrylate.

For example, at least one selected from methyl methacrylate, ethyl methacrylate, isopropyl methacrylate, n-butyl methacrylate, isobutyl methacrylate, cyclohexyl methacrylate and 2-ethylhexyl methacrylate is favorably used as the alkyl methacrylate.

As the carboxylic acid-containing unsaturated monomer, for example, an unsaturated carboxylic acid, such as acrylic acid, methacrylic acid or the like, or its half ester is favorably used, or a mixture of at least two monomers may be used. Particularly, acrylic acid and methacrylic acid, which have the simplest structure, are favorably used.

In the resin component the copolymer may be further copolymerized with a monomer which produces a homopolymer soluble in water. Examples of such copolymerizable monomers include (meth)acrylates each having an alkoxyalkyl group, such as methoxymethyl (meth)acrylate; (meth)acrylates each having an alkyloxy group substituted alkylene glycol moiety, such as methoxypolyethylene glycol (meth)acrylate (n=2, 3, 4, 8, 24), (meth)acrylates each having an alkyl group having a hydroxyl group, such as 2-hydroxyethyl (meth)acrylate, 2-hydroxybutyl (meth)acrylate, and the like.

Other copolymerizable monomers include (meth)acrylonitrile, acrylamide, N-methylolacrylamide, styrene, ethylene, vinyl acetate, N-vinylpyrrolidone, glycidyl methacrylate, and the like.

When the resin component contained in the water-soluble acrylic binder is converted to a salt by neutralization, solubility in water is improved, and a solution has neutral pH to improve handleability. Since the binder preferably produces small amounts of residual components after burning, ammonium ions are preferably used for the salification. Although ammonia water can easily be used for providing ammonium ions, any one of primary, secondary, tertiary and quaternary organic amines may be used. Examples of organic amines include monoethanolamine (primary), diethanolamine (secondary), triethanolamine (tertiary), and the like.

Furthermore, any desired content of the water-soluble acrylic binder can be contained in the ceramic slurry composition of the present invention. For example, about 2.5 to 62.5 parts by weight, preferably about 12.5 to 37.5 parts by weight (containing about 1 to 25 parts by weight of the resin component, preferably about 5 to 15 of the resin component) of the water-soluble acrylic binder based on 100 parts by weight of the ceramic raw material powder can be present. Also, for example, about 10 to 150 parts by weight, of preferably 50 to 100 parts by weight of, water based on 100 parts by weight of the ceramic raw material powder can be present.

Typical examples of materials for the ceramic raw material powder include oxides such as alumina, zirconia, titanium oxide, barium titinate, lead zirconate titanate, manganese ferrite, and the like.

The ceramic slurry composition may further contain a water-soluble plasticizer such as polyethylene glycol, glycerin or the like, molding auxiliaries such as a dispersant, a defoarming agent, an antistatic agent, and the like.

### EXPERIMENTAL EXAMPLE 1

(Samples 1 to 18)

First, barium carbonate (BaCO₃) and titanium oxide (TiO₂) were weighed at a molar ratio of 1:1, mixed in a wet manner using a ball mill, and then dehydrated. Then, the resultant mixture was calcined at a temperature of 1000° C. for 2 hours and then ground to form a ceramic raw material powder.

Also, a water-soluble acrylic binder was produced by the method described below.

230 g of methanol and 35 g of pure water were charged in a 1 liter separation flask provided with a stirrer, a thermometer, a reflux condenser, a dropping funnel, and a gas inlet tube, and 0.42 g of a polymerization initiator AIBN (α,α′-azobisisobutyronitrile) was charged in the flask. The mixture was heated to a temperature of 65° C. under a nitrogen gas stream.

Acrylic acid as a carboxylic acid-containing unsaturated monomer and methyl acrylate as an alkyl acrylate were mixed at each of the ratios shown in “Amount of acrylic acid (% by weight)” in Tables 1 to 5. In Samples 1 to 11, 1.0 g of acrylic acid and 99.0 g of methyl acrylate were mixed, and in Samples 12 to 18, 7.0 g of acrylic acid and 93.0 g of methyl acrylate were mixed, so that the total weight was 100 g.

Next, the mixture of each of Samples 1 to 18 was added dropwisely to the flask from the dropping funnel over 2 hours, kept at constant temperature for 1 hour and then polymerized under reflux for 2 hours to complete polymerization. As a result, a mixed solution containing a resin component for forming a water-soluble acrylic binder was obtained.

Next, each of the mixed solutions containing the resin components comprising a copolymer was neutralized with ammonia water. Furthermore, 170 g of pure water was added to the mixed solution, and then the mixture was stirred for about 15 minutes.

Next, concentration was performed by heating distillation at 90° C. under normal pressure.

In further detail, as shown in “Amount of water added” in Tables 1 and 4, 10 g, 20 g, 30 g, 10 g, 20 g and 30 g of pure water were respectively added in Samples 2, 3, 4, 13, 14 and 15 when the resin content was 25% by weight during the course of concentration.

Similarly, as shown in “Amount of water added” in Table 2, 18 g, 30 g, 70 g, and 100 g of pure water were respectively added in Samples 5, 6, 7 and 8 when the resin content was 30% by weight during the course of concentration.

Furthermore, as shown in “Amount of water added” in Tables 3 and 5, 20 g, 30 g, 50 g, 20 g, 30 g and 50 g of pure water were respectively added in Samples 9, 10, 11, 16, 17 and 18 when the resin content was 35% by weight during the course of concentration.

In Samples 1 and 12, no water was added.

The resin content at the time of the addition of pure water in the concentration step is shown in “Resin content after addition” in each of Tables 1 to 5.

Also, the methanol concentration at the time of the addition of pure water is shown in “Alcohol content after addition” in each of Tables 1 to 5.

After the pure water was added as described above, concentration was again performed.

In each of Samples 2, 3, 4, 13, 14 and 15, the methanol concentration and viscosity when the resin content became again 25% by weight are shown in “Alcohol content” and “Viscosity”, respectively, of “25% re-concentration” in Tables 1 and 4, and the methanol concentration and viscosity when the resin content became again 35% by weight are shown in “Alcohol content” and “Viscosity”, respectively, in “35% concentration” in Tables 1 and 4.

Also, in each of Samples 5, 6, 7 and 8, the methanol concentration and viscosity when the resin content became again 30% by weight are shown in “Alcohol content” and “Viscosity”, respectively, in “30% re-concentration” in Table 2.

Furthermore, in each of Samples 9, 10, 11, 16, 17 and 18, the methanol concentration and viscosity when the resin content became again 35% by weight are shown in “Alcohol content” and “Viscosity”, respectively, in “35% re-concentration” in Tables 3 and 5.

When the concentration step was further performed to decrease the evaporation rate, concentration was promoted by bubbling with nitrogen. The concentration step was terminated when the resin content was 40% by weight.

The methanol concentration and viscosity when the resin content became 40% by weight are shown in “Alcohol content” and “Viscosity”, respectively, in “40% concentration” in Tables 1 to 5.

The alcohol content was measured by diluting 0.5 g of each water-soluble acrylic binder with 20 ml of tetrahydrofuran and then determining the alcohol content by GC (gas chromatography).

The weightaverage molecular weight and inertial square radius of each of the resultant water-soluble acrylic binders shown in Tables 1 to 5 were determined as described below.

The weightaverage molecular weight of each water-soluble acrylic binder was measured by gel permeation chromatography (“GPC-104” produced by Showa Denko K. K.) using tetrahydrofuran as a solvent, and polystyrene as a reference substance.

The inertial square radius of each water-soluble acrylic binder was measured by a light scattering photometer (“DSL-7000” produced by Otsuka Denshi Co., Ltd.). The measurement was performed for each water-soluble acrylic binder at a sample concentration of each of 2.0 g/l, 4.0 g/l and 6.0 g/l in an aqueous solution, with an argon laser 75 mW (632.8 nm) as a light source at a measurement temperature of 25° C. In a pre-treatment, each water-soluble acrylic binder was filtered using a 0.22 μm filter. The inertial square radius represents the molecular size in an aqueous solution.

Next, 100 parts by weight of the prepared ceramic raw material powder, an ammonium polyacrylate dispersant in an amount of 0.5 part by weight in terms of resin component, each of the water-soluble acrylic binders (Mw of the resin component: 200,000) in an amount of 7 parts by weight in terms of resin component, 2 parts by weight of ethylene glycol as a plasticizer, and a total of 70 parts by weight of pure water were charged in a ball mill together with 650 parts by weight of zirconia balls of 5 mm in diameter, the water-soluble acrylic binders having different residual alcohol (methanol) amounts. Then, each of the mixtures was mixed for 20 hours in a wet manner to form a ceramic slurry composition.

When the ceramic slurry composition had a slurry viscosity of over 200 mPa·s, the slurry had low dispersibility to decrease the molding density of a ceramic green sheet to less than 3.60, as shown in “Sheet molding density without water addition” in Tables 1 to 5. Therefore, water was added in the amount shown in the “Amount of water added for controlling slurry viscosity” in Tables 1 to 5 so as to control the slurry viscosity to 200 mPa·s or less.

The ceramic slurry composition was formed into a ceramic green sheet having a thickness of 60 μm by a doctor blade method. Then, the ceramic green sheet was dried at 80° C. for 5 minutes.

The ceramic green sheet obtained with each of Samples 1 to 18 was evaluated with respect to sheet molding density, sheet tensile strength, sheet elongation percentage and cracking, as shown in Tables 1 to 5.

The sheet molding density was measured by a method in which the molded ceramic green sheet was cut into a tetragonal specimen of a size of 50 mm×70 mm, and the volume of the tetragonal specimen, which was determined by the measurement of the average thickness, was divided by the measured weight. The sheet molding density increases as dispersibility becomes excellent.

The sheet tensile strength and sheet elongation percentage were measured by a method in which both ends of the cut specimen of the ceramic green sheet were fixed by a chuck (chuck space: 30 mm) of a tensile tester, and then pulled at a constant rate (10 mm/min). More specifically, the sheet tensile strength is represented by the maximum tensile strength immediately before the ceramic green sheet sample was cut. The sheet elongation percentage is represented by a value obtained by dividing the sheet elongation by the chuck space. These values increase as dispersibility increases and the toughness of the binder increases.

An evaluation of cracking was made for evaluating the drying property by observing whether or not cracks occurred in the ceramic green sheet during drying after molding of the sheet of 60 82 m in thickness. In each of Tables 1 to 5, a sample in which cracks were observed is marked with “x” and one where there were no cracks is marked with “0”.

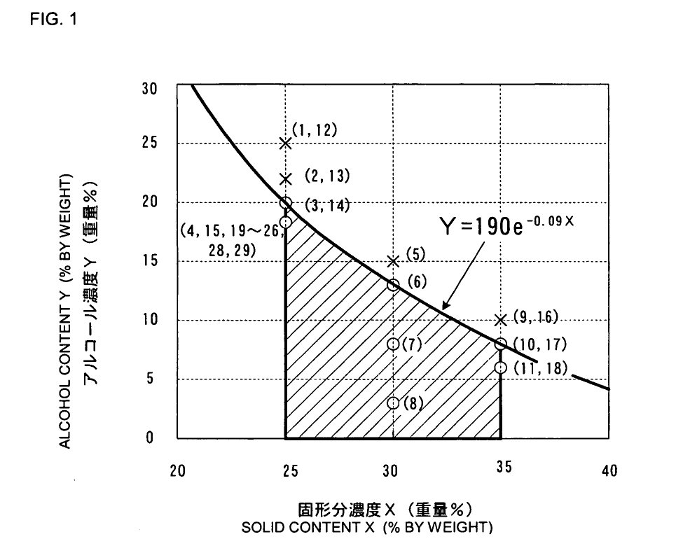

The indications under the heading “Overall evaluation” refer to FIG. 1, as described later.

TABLE 1

| | | | Sample No. | | | |
|---|---|---|---|---|---|---|
| | | | 1 | 2 | 3 | 4 |
| Amount of acrylic acid | | % by weight | 1.0 | 1.0 | 1.0 | 1.0 |
| Weight-average molecular weight | | | 200000 | 200000 | 200000 | 200000 |
| Inertial square radius | | nm | 150 | 110 | 75 | 60 |
| Amount of water added | | g | 0 | 10 | 20 | 30 |
| Resin content after water addition | | % by weight | 25 | 24.4 | 23.8 | 23.3 |
| Alcohol content after water addition | | % by weight | 25 | 24.4 | 23.8 | 23.3 |
| 25% re- | Alcohol content | % by weight | 25 | 22 | 20 | 18 |
| concentration | Viscosity | mPa · s | 60000 | 30000 | 500 | 300 |
| 35% | Alcohol content | % by weight | 13 | 10 | 8 | 6 |
| concentration | Viscosity | mPa · s | 90000 | 50000 | 1000 | 500 |
| 40% | Alcohol content | % by weight | 10 | 7 | 5 | 3 |
| concentration | Viscosity | mPa · s | 150000 | 80000 | 5000 | 1000 |

| | | | | | |
|---|---|---|---|---|---|
| Sheet molding density without water | g/cm³ | 3.50 | 3.55 | 3.62 | 3.62 |
| addition | | | | | |
| Amount of water added for controlling | g | 20 | 10 | 0 | 0 |
| slurry viscosity | | | | | |
| Sheet molding density | g/cm³ | 3.62 | 3.62 | 3.62 | 3.62 |
| Sheet tensile strength | MPa | 4.90 | 4.90 | 4.90 | 4.90 |
| Sheet elongation percentage | % | 11.0 | 11.0 | 11.0 | 11.0 |
| Crack decision | | x | x | ∘ | ∘ |
| Overall evaluation | | x | x | ∘ | ∘ |

TABLE 2

| | | | Sample No. | | | |
|---|---|---|---|---|---|---|
| | | | 5 | 6 | 7 | 8 |
| Amount of acrylic acid | | % by weight | 1.0 | 1.0 | 1.0 | 1.0 |
| Weight-average molecular weight | | | 200000 | 200000 | 200000 | 200000 |
| Inertial square radius | | nm | 110 | 75 | 50 | 40 |
| Amount of water added | | g | 18 | 30 | 70 | 100 |
| Resin content after water addition | | % by weight | 28.5 | 27.5 | 24.8 | 23.1 |
| Alcohol content after water addition | | % by weight | 16.6 | 16.3 | 14.7 | 13.7 |
| 30% re- | Alcohol content | % by weight | 15 | 13 | 8 | 3 |
| concentration | Viscosity | mPa · s | 55000 | 2200 | 50 | 30 |
| 40% | Alcohol content | % by weight | 7 | 5 | 0.2 | 0 |
| concentration | Viscosity | mPa · s | 80000 | 5000 | 100 | 50 |

| | | | | | |
|---|---|---|---|---|---|
| Sheet molding density without water | g/cm³ | 3.55 | 3.62 | 3.62 | 3.62 |
| addition | | | | | |
| Amount of water added for controlling | g | 10 | 0 | 0 | 0 |
| slurry viscosity | | | | | |
| Sheet molding density | g/cm³ | 3.62 | 3.62 | 3.62 | 3.62 |
| Sheet tensile strength | MPa | 4.90 | 4.90 | 4.90 | 4.90 |
| Sheet elongation percentage | % | 11.0 | 11.0 | 11.0 | 11.0 |
| Crack decision | | x | ∘ | ∘ | ∘ |
| Overall evaluation | | x | ∘ | ∘ | ∘ |

TABLE 3

| | | | Sample No. | | |
|---|---|---|---|---|---|
| | | | 9 | 10 | 11 |
| Amount of acrylic acid | | % by weight | 1.0 | 1.0 | 1.0 |
| Weight-average molecular weight | | | 200000 | 200000 | 200000 |
| Inertial square radius | | Nm | 110 | 75 | 60 |
| Amount of water added | | G | 20 | 30 | 50 |
| Resin content after water addition | | % by weight | 32.7 | 31.6 | 29.8 |
| Alcohol content after water addition | | % by weight | 12.1 | 11.8 | 11.1 |
| 35% re- | Alcohol content | % by weight | 10 | 8 | 6 |
| concentration | Viscosity | mPa · s | 50000 | 1000 | 500 |
| 40% | Alcohol content | % by weight | 7 | 5 | 3 |
| concentration | Viscosity | mPa · s | 80000 | 5000 | 1000 |

| | | | | |
|---|---|---|---|---|
| Sheet molding density without water | g/cm³ | 3.55 | 3.62 | 3.62 |
| addition | | | | |
| Amount of water added for controlling | G | 10 | 0 | 0 |
| slurry viscosity | | | | |
| Sheet molding density | g/cm³ | 3.62 | 3.62 | 3.62 |
| Sheet tensile strength | MPa | 4.90 | 4.90 | 4.90 |
| Sheet elongation percentage | % | 11.0 | 11.0 | 11.0 |
| Crack decision | | x | ∘ | ∘ |
| Overall evaluation | | x | ∘ | ∘ |

TABLE 4

| | | Sample No. | | | |
|---|---|---|---|---|---|
| | | 12 | 13 | 14 | 15 |
| Amount of acrylic acid | % by weight | 7.0 | 7.0 | 7.0 | 7.0 |
| Weight-average molecular weight | | 200000 | 200000 | 200000 | 200000 |
| Inertial square radius | Nm | 200 | 150 | 100 | 80 |
| Amount of water added | G | 0 | 10 | 20 | 30 |
| Resin content after water addition | % by weight | 25 | 24.4 | 23.8 | 23.3 |
| Alcohol content after water addition | % by weight | 25 | 24.4 | 23.8 | 23.3 |

| | | | | | | |
|---|---|---|---|---|---|---|
| 25% re- | Alcohol content | % by weight | 25 | 22 | 20 | 18 |
| concentration | Viscosity | mPa · s | 600000 | 300000 | 5000 | 3000 |
| 35% | Alcohol content | % by weight | 13 | 10 | 8 | 6 |
| concentration | Viscosity | mPa · s | 900000 | 500000 | 10000 | 5000 |
| 40% | Alcohol content | % by weight | 10 | 7 | 5 | 5 |
| concentration | Viscosity | mPa · s | 1500000 | 800000 | 50000 | 10000 |

| | | | | | |
|---|---|---|---|---|---|
| Sheet molding density without water | g/cm³ | 3.50 | 3.55 | 3.62 | 3.62 |
| addition | | | | | |
| Amount of water added for controlling | G | 20 | 10 | 0 | 0 |
| slurry viscosity | | | | | |
| Sheet molding density | g/cm³ | 3.62 | 3.62 | 3.62 | 3.62 |
| Sheet tensile strength | Mpa | 4.90 | 4.90 | 4.90 | 4.90 |
| Sheet elongation percentage | % | 11.0 | 11.0 | 11.0 | 11.0 |
| Crack decision | | x | x | ∘ | ∘ |
| Overall evaluation | | x | x | ∘ | ∘ |

TABLE 5

| | | | Sample No. | | |
|---|---|---|---|---|---|
| | | | 16 | 17 | 18 |
| Amount of acrylic acid | | % by weight | 7.0 | 7.0 | 7.0 |
| Weight-average molecular weight | | | 200000 | 200000 | 200000 |
| Inertial square radius | | Nm | 150 | 100 | 80 |
| Amount of water added | | G | 20 | 30 | 50 |
| Resin content after water addition | | % by weight | 32.7 | 31.6 | 29.8 |
| Alcohol content after water addition | | % by weight | 12.1 | 11.8 | 11.1 |
| 35% re- | Alcohol content | % by weight | 10 | 8 | 6 |
| concentration | Viscosity | mPa · s | 500000 | 10000 | 5000 |
| 40% | Alcohol content | % by weight | 7 | 5 | 3 |
| concentration | Viscosity | mPa · s | 800000 | 50000 | 10000 |

| | | | | |
|---|---|---|---|---|
| Sheet molding density without water | g/cm³ | 3.55 | 3.62 | 3.62 |
| addition | | | | |
| Amount of water added for controlling | G | 10 | 0 | 0 |
| slurry viscosity | | | | |
| Sheet molding density | g/cm³ | 3.62 | 3.62 | 3.62 |
| Sheet tensile strength | MPa | 4.90 | 4.90 | 4.90 |
| Sheet elongation percentage | % | 11.0 | 11.0 | 11.0 |
| Crack decision | | x | ∘ | ∘ |
| Overall evaluation | | x | ∘ | ∘ |

(Samples 19 to 21)

Experiments were carried out to prepare Samples 19 to 21 for confirming that the type of the alcohol used has no influence.

A water-soluble acrylic binder, a ceramic slurry composition and a ceramic green sheet were prepared by the same method as that for Samples 2 to 4 and 13 to 15, and evaluated by the same method except the following points.

Namely, in each of Samples 19 to 21, 5.0 g of acrylic acid as a carboxylic acid-containing monomer and 95.0 g of methyl acrylate as an alkyl acrylate were mixed so that the total weight was 100 g, as shown “Amount of acrylic acid (% by weight)” in Table 6.

Also, in Samples 19, 20 and 21, methanol, ethanol, and IPA (isopropyl alcohol) were respectively used as an alcohol as a solvent for copolymerization of the acrylic acid and methyl acrylate, as shown in “Alcohol” in Table 6.

TABLE 6

| | | | Sample No. | | |
|---|---|---|---|---|---|
| | | | 19 | 20 | 21 |
| Alcohol | | | Methanol | Ethanol | IPA |
| Amount of acrylic acid | | % by weight | 5.0 | 5.0 | 5.0 |
| Weight-average molecular weight | | | 200000 | 100000 | 10000 |
| Inertial square radius | | Nm | 70 | 68 | 64 |
| Amount of water added | | G | 30 | 30 | 30 |
| Resin content after water addition | | % by weight | 23.3 | 23.3 | 23.3 |
| Alcohol content after water addition | | % by weight | 23.3 | 23.3 | 23.3 |
| 25% re- | Alcohol content | % by weight | 18 | 18 | 18 |
| concentration | Viscosity | mPa · s | 500 | 400 | 150 |
| 35% | Alcohol content | % by weight | 6 | 6 | 6 |
| concentration | Viscosity | mPa · s | 1000 | 800 | 250 |
| 40% | Alcohol content | % by weight | 3 | 3 | 3 |
| concentration | Viscosity | mPa · s | 5000 | 4000 | 1500 |

| | | | | |
|---|---|---|---|---|
| Sheet molding density without water | g/cm³ | 3.62 | 3.62 | 3.62 |
| addition | | | | |
| Amount of water added for controlling | G | 0 | 0 | 0 |
| slurry viscosity | | | | |
| Sheet molding density | g/cm³ | 3.62 | 3.62 | 3.62 |
| Sheet tensile strength | MPa | 4.90 | 4.60 | 4.20 |
| Sheet elongation percentage | % | 11.0 | 8.0 | 7.0 |
| Crack decision | | ∘ | ∘ | ∘ |
| Overall evaluation | | ∘ | ∘ | ∘ |

(Samples 22 to 24)

Experiments were carried out to prepare Samples 22 to 24 to confirming that the type of the alkyl (meth)acrylate used has no influence.

A water-soluble acrylic binder, a ceramic slurry composition and a ceramic green sheet were prepared by the same method as that for Samples 2 to 4 and 13 to 15, and evaluated by the same method except the following points.

Namely, ethyl acrylate, butyl acrylate and methyl acrylate and methyl methacrylate were respectively used as an alkyl (meth)acrylate in Samples 22, 23 and 24 as shown in “Alkyl (meth)acrylate” in Table 7.

Also, in each of Samples 22 to 24, 5.0 g of acrylic acid as a carboxylic acid-containing monomer and 95.0 g of the alky (meth)acrylate were mixed so that the total weight was 100 g, as shown in “Amount of acrylic acid (% by weight)” in Table 7. In Sample 24, a mixture of 15 g of methyl methacrylate and 80 g of methyl acrylate was used as the alkyl (meth)acrylate.

TABLE 7

| | | | Sample No. | | |
|---|---|---|---|---|---|
| | | | 22 | 23 | 24 |
| Alkyl (meth)acrylate | | | Ethyl | Butyl | Methyl acrylate |
| | | | acrylate | acrylate | Methyl methacrylate |
| Amount of acrylic acid | | % by weight | 5 | 5 | 5 |
| Weight-average molecular weight | | | 200000 | 200000 | 200000 |
| Inertial square radius | | Nm | 68 | 65 | 68 |
| Amount of water added | | G | 30 | 30 | 30 |
| Resin content after water addition | | % by weight | 23.3 | 23.3 | 23.3 |
| Alcohol content after water addition | | % by weight | 23.3 | 23.3 | 23.3 |
| 25% re- | Alcohol content | % by weight | 18 | 18 | 18 |
| concentration | Viscosity | mPa · s | 400 | 350 | 400 |
| 35% | Alcohol content | % by weight | 6 | 6 | 6 |
| concentration | Viscosity | mPa · s | 800 | 700 | 800 |
| 40% | Alcohol content | % by weight | 3 | 3 | 3 |
| concentration | Viscosity | mPa · s | 4000 | 3500 | 4000 |

| | | | | |
|---|---|---|---|---|
| Sheet molding density without water | g/cm³ | 3.62 | 3.62 | 3.62 |
| addition | | | | |
| Amount of water added for controlling | G | 0 | 0 | 0 |
| slurry viscosity | | | | |
| Sheet molding density | g/cm³ | 3.62 | 3.62 | 3.62 |
| Sheet tensile strength | MPa | 4.40 | 3.90 | 5.20 |
| Sheet elongation percentage | % | 12.0 | 14.0 | 10.0 |
| Crack decision | | ∘ | ∘ | ∘ |
| Overall evaluation | | ∘ | ∘ | ∘ |

(Sample 25)

Experiments were carried out to prepare Sample 25 for confirming that acrylic acid as a carboxylic acid-containing monomer may be replaced by methacrylic acid.

A water-soluble acrylic binder, a ceramic slurry composition and a ceramic green sheet were prepared by the same method as that for Samples 2 to 4 and 13 to 15, and evaluated by the same method except the following points.

Namely, methacrylic acid was used as the carboxylic acid-containing monomer.

Also, 5.0 g of methacrylic acid and 95.0 g of methyl acrylate as the alkyl acrylate were mixed so that the total weight was 100 g, as shown in “Amount of methacrylic acid(% by weight)” in Table 8.

TABLE 8

| Sample No. | | | 25 |
|---|---|---|---|
| Amount of acrylic acid | | % by weight | 5.0 |
| Weight-average molecular weight | | | 200000 |
| Inertial square radius | | nm | 68 |
| Amount of water added | | g | 30 |
| Resin content after water addition | | % by weight | 23.3 |
| Alcohol content after water addition | | % by weight | 23.3 |
| 25% re- | Alcohol content | % by weight | 18 |
| concentration | Viscosity | mPa · s | 400 |
| 35% | Alcohol content | % by weight | 6 |
| concentration | Viscosity | mPa · s | 800 |
| 40% | Alcohol content | % by weight | 3 |
| concentration | Viscosity | mPa · s | 4000 |

| | | |
|---|---|---|
| Sheet molding density without water | g/cm³ | 3.62 |
| addition | | |
| Amount of water added for controlling | g | 0 |
| slurry viscosity | | |
| Sheet molding density | g/cm³ | 3.62 |
| Sheet tensile strength | MPa | 5.20 |
| Sheet elongation percentage | % | 10.0 |
| Crack decision | | ∘ |
| Overall evaluation | | ∘ |

(Samples 26 and 27)

Experiments were carried out to prepare Samples 26 and 27 for determining the threshold value of the weightaverage molecular weight of the resin component contained in the water-soluble acrylic binder.

A water-soluble acrylic binder, a ceramic slurry composition and a ceramic green sheet were prepared by the same method as that for Samples 2 to 4 and 13 to 15, and evaluated by the same method except the following points.

Namely, 230 g of methanol and 35 g of pure water were charged in a separation flask of 1 liter provided with a stirrer, a thermometer, a reflux condenser, a dropping funnel and a gas inlet tube, and 0.21 g of a polymerization initiator AIBN (α,α′-azobisisobutyronitrile) was charged in the flask. In Sample 26, the mixture was heated to a temperature of 60° C. under a nitrogen gas stream, and in Sample 27, the mixture was heated to a temperature of 58° C. under a nitrogen gas stream.

Also, 5.0 of acrylic acid as a carboxylic acid-containing unsaturated monomer and 95.0 g of methyl acrylate as an alkyl acrylate were mixed so that the total weight was 100 g in both Samples 26 and 27, as show in “Amount of acrylic acid (% by weight)” in Table 9.

TABLE 9

| Sample No. | | | 26 | 27 |
|---|---|---|---|---|
| Amount of acrylic acid | | % by weight | 5 | 5 |
| Weight-average molecular weight | | | 500000 | 600000 |
| Inertial square radius | | nm | 90 | 120 |
| Amount of water added | | g | 30 | 30 |
| Resin content after water addition | | % by weight | 23.3 | 23.3 |
| Alcohol content after water | | % by weight | 23.3 | 23.3 |
| addition | | | | |
| 25% re- | Alcohol content | % by weight | 18 | 18 |
| concentration | Viscosity | mPa · s | 1000 | 5500 |
| 35% | Alcohol content | % by weight | 8 | 6 |
| concentration | Viscosity | mPa · s | 2000 | 11000 |
| 40% | Alcohol content | % by weight | 3 | 3 |
| concentration | Viscosity | mPa · s | 10000 | 55000 |

| | | | |
|---|---|---|---|
| Sheet molding density without | g/cm³ | 3.62 | 3.57 |
| water addition | | | |
| Amount of water added for | g | 0 | 5 |
| controlling slurry viscosity | | | |
| Sheet molding density | g/cm³ | 3.62 | 3.62 |
| Sheet tensile strength | MPa | 5.20 | 5.30 |
| Sheet elongation percentage | % | 13.0 | 14.0 |
| Crack decision | | ∘ | x |
| Overall evaluation | | ∘ | x |

(Samples 28 to 30)

Experiments were carried out to prepare Samples 28 to 30 for confirming the influence of a change of the temperature within the range of 92 to 100° C. during concentration.

A water-soluble acrylic binder, a ceramic slurry composition and a ceramic green sheet were prepared by the same method as that for Samples 2 to 4 and 13 to 15, and evaluated by the same method except the following points.

Namely, concentration was performed by heating distillation under normal pressure at 92° C., 96° C. and 100° C. in Samples 28, 29 and 30, respectively.

Also, 5.0 g of acrylic acid as a carboxylic acid-containing unsaturated monomer and 95.0 g of methyl acrylate as an alkyl acrylate were mixed so that the total weight was 100 g in Samples 28 to 30, as show in “Amount of acrylic acid (% by weight)” in Table 10.

TABLE 10

| | | | Sample No. | | |
|---|---|---|---|---|---|
| | | | 28 | 29 | 30 |
| Concentration temperature | | ° C. | 92 | 96 | 100 |
| Amount of acrylic acid | | % by weight | 5.0 | 5.0 | 5.0 |
| Weight-average molecular weight | | | 200000 | 200000 | 200000 |
| Inertial square radius | | Nm | 70 | 65 | unmeasurable |
| Amount of water added | | G | 30 | 30 | 30 |
| Resin content after water addition | | % by weight | 23.3 | 23.3 | 23.3 |
| Alcohol content after water addition | | % by weight | 23.3 | 23.3 | 23.3 |
| 25% re- | Alcohol content | % by weight | 18 | 18 | 18 |
| concentration | Viscosity | mPa · s | 500 | 500 | 150 |
| 35% | Alcohol content | % by weight | 6 | 6 | 6 |
| concentration | Viscosity | mPa · s | 1000 | 1000 | 500 |
| 40% | Alcohol content | % by weight | 3 | 3 | 3 |
| concentration | Viscosity | mPa · s | 5000 | 3000 | 40 |

| | | | | |
|---|---|---|---|---|
| Sheet molding density without water | g/cm³ | 3.62 | 3.62 | 3.42 |
| addition | | | | |
| Amount of water added for controlling | G | 0 | 0 | 0 |
| slurry viscosity | | | | |
| Sheet molding density | g/cm³ | 3.62 | 3.62 | 3.42 |
| Sheet tensile strength | MPa | 4.90 | 4.90 | 3.90 |
| Sheet elongation percentage | % | 11.0 | 11.0 | 5.0 |
| Crack decision | | ∘ | ∘ | ∘ |
| Overall evaluation | | ∘ | ∘ | x |

(Sample 31)

Sample 31 corresponding to a comparative example was prepared without passing through the step of adding water during the course of concentration and then again performing concentration.

A ceramic raw material powder was prepared by the same method as in Samples 1 to 18.

A water-soluble acrylic binder with a low molecular weight was formed by the method described below.

230 g of methanol and 35 g of pure water were charged in a separation flask of 1 liter provided with a stirrer, a thermometer, a reflux condenser, a dropping funnel, and a gas inlet tube, and 0.84 g of a polymerization initiator AIBN (α,α′-azobisisobutyronitrile) was charged in the flask. The mixture was heated to a temperature of 67° C. under a nitrogen gas stream.

Also, 5.0 g of acrylic acid as a carboxylic acid-containing unsaturated monomer and 95.0 g of methyl acrylate as an alkyl acrylate were mixed so that the total weight was 100 g, as shown in “Amount of acrylic acid (% by weight)” in Table 11.

Next, the mixture was added dropwisely to the mixture in the flask from the dropping funnel over 2 hours, kept at constant temperature for 1 hour and then polymerized under reflux for 2 hours to complete the polymerization. As a result, a mixed solution containing a resin component for forming a water-soluble acrylic binder was obtained.

Next, the mixed solution containing the resin component comprising a copolymer was neutralized with ammonia water. Furthermore, 170 g of pure water was added to the mixed solution, and then the mixture was stirred for about 15 minutes.

Next, concentration was performed by heating distillation at 90° C. under normal pressure, and then terminated when the resin content was 40% by weight.

The methanol concentration and viscosity when the resin content was 40% by weight are shown in “Alcohol content” and “Viscosity”, respectively, in “40% concentration” in Table 11.

A ceramic slurry composition and a ceramic green sheet were prepared by the same method as that for Samples 1 to 8 using the resultant lowmolecularweight water-soluble acrylic binder, and evaluated by the same method.

TABLE 11

| Sample No. | | | 31 |
|---|---|---|---|
| Amount of acrylic acid | | % by weight | 5.0 |
| Weight-average molecular weight | | | 6000 |
| Inertial square radius | | nm | 40 |
| 40% | Alcohol content | % by weight | 10 |
| concentration | Viscosity | mPa · s | 1000 |

| | | |
|---|---|---|
| Sheet molding density without water | g/cm³ | 3.62 |
| addition | | |
| Amount of water added for controlling | g | 0 |
| slurry viscosity | | |
| Sheet molding density | g/cm³ | 3.62 |
| Sheet tensile strength | MPa | 3.70 |
| Sheet elongation percentage | % | 3.6 |
| Crack decision | | ∘ |
| Overall evaluation | | x |

In the step of adding water to the mixed solution to form a water-added solution and concentrating the water-added solution containing a resin component for the water-soluble acrylic binder in such a manner that water was added during the course of concentration and then concentration was again performed, to obtain each of Samples 1 to 26, 28 and 29, the same resin content as that immediately before the addition of water was obtained by re-concentration after water was added. FIG. 1 shows the relationship between the resin content X and alcohol content Y when the same resin content as that immediately before the addition of water was obtained.

In FIG. 1, the resin content is shown on the abscissa and the alcohol content is shown on the ordinate. Also, the resin content X and alcohol content Y of each sample are shown by coordinates at a position marked with ◯ or x. The marks “◯” and “x” correspond to the marks “◯” and “x”, respectively, shown in “Overall evaluation” in each table, and the corresponding sample number is parenthesized near each of the marks “◯” and “x”.

For example, Sample 3 is shown by the coordinates (X, Y)=(25, 20) at a point with marked with ◯ in FIG. 1. Of the coordinates, X of 25 means “25% re-concentration” in Table 1, and Y of 20 means the alcohol content shown in “Alcohol content” at “25% re-concentration” in Table 1.

Referring to FIG. 1, the boundary between desirable samples marked with ◯ and undesirable samples marked with x is presented by the equation Y=190e^{-0.09X} (wherein 25≦X≦35). Therefore, the desirable samples marked with ◯ satisfy the relation represented by the formula Y=190e^{-0.09X}.

As described above, it is found that by using Samples 3, 4, 6, 7, 8, 10, 11, 14, 15, 17 to 26, 28 and 29 marked with ◯ and satisfying the equation Y=190e^{-0.09X}, the alcohol content at a resin content of 40% by weight is about 5% by weight or less, and the solution viscosity is about 50 to 50,000 mPa·s, as shown in Tables 1 to 10.

It is also found that with these Samples 3, 4, 6, 7, 8, 10, 11, 14, 15, 17 to 26, 28 and 29, the defects of a water-soluble acrylic binder containing a hydrophobic component as a main component, i.e., high slurry viscosity, low moldability of a thick sheet, etc., are resolved.

In these Samples 3, 4, 6, 7, 8, 10, 11, 14, 15, 17 to 26, 28 and 29, the amount C (g) of the water added during the course of concentration satisfies the relationship 190e^{-0.09X}/100+0.033≧(A+B/100)/(A+C) (wherein A is the total amount (g) of the water-added solution at the time of the addition of water, and B is the measured alcohol content (% by weight) of the water-added solution at the time of the addition of water).

Sample 31 is a comparative example was prepared by using a water-soluble acrylic binder of a low molecular weight in order to decrease the slurry viscosity. With this sample, as shown in Table 11, both the sheet tensile strength and sheet elongation percentage are decreased. However, it is found that with Samples 3, 4, 6, 7, 8, 10, 11, 14, 15, 17 to 26, 28 and 29, these defects are resolved.

Although Sample 30 was prepared through the step of adding water during the course of concentration and again performing concentration to satisfy the relationship Y=190e^{-0.09X}, the temperature of heating distillation in the concentration step exceeded 96° C., and thus the water-soluble acrylic binder deteriorates to an extent with which the inertial square radius cannot be measured. Therefore, the sheet molding density is decreased.

Although Sample 27 was prepared through the step of adding water during the course of concentration and again performing concentration to satisfy the relationship Y=190e^{-0.09X}, the weightaverage molecular weight of the resin component contained in the water-soluble acrylic binder exceeds 500,000, and the inertial square radius exceeds 100 nm. Therefore, when the resin content of the water-soluble acrylic binder is set to 40% by weight by concentration, the solution viscosity exceeds 50,000 mPa·s. Therefore, water is added to the ceramic slurry composition to control the slurry viscosity to 200 mPa·s or less. As shown in “Crack decision” in Table 5, cracks occur in Sample 27, and the drying property is also poor.

On the other hand, in Samples 1, 2, 5, 9, 12, 13 and 16, the relationship Y=190e^{-0.09X} is not satisfied in the concentration step, and water is added to the resultant ceramic slurry composition to control the slurry viscosity to 200 mPa·s or less, as described above. With these Samples 1, 2, 5, 9, 12, 13 and 16, it is fount that cracks occur, and the drying property is poor, as shown in “Crack decision” in Tables 1 to 5.

As a result of comparison between Samples 1 to 4 shown in Table 1, between Samples 5 to 8 shown in Table 2, between Samples 9 to 11 shown in Table 3, between Samples 12 to 15 shown in Table 4, and between Samples 16 to 18 shown in Table 5, it is found that the viscosity of a sample having an alcohol content of about 5% by weight or less when the resin content is set to 40% by weight by concentration is significantly decreased, as compared a sample having an alcohol content of over about 5% by weight. Therefore, when the alcohol content is about 5% by weight or less at the resin content of 40% by weight, the viscosity can be decreased, and a ceramic slurry composition having excellent sheet moldability can be obtained.

### EXPERIMENTAL EXAMPLE 2

Experimental Example 2 was carried out for evaluating the influence of pH of a water-soluble acrylic binder containing a resin component, and the influence of pH of a ceramic slurry composition obtained by using the binder.

First, barium carbonate (BaCO₃) and titanium oxide (TiO₂) were weighed at a molar ratio of 1:1, mixed in a wet manner using a ball mill, and then dehydrated. Then, the resultant mixture was calcined at a temperature of 1000° C. for 2 hours, and then ground to form a ceramic raw material powder.

Also, a water-soluble acrylic binder was produced by the method described below.

200 g of methanol and 50 g of pure water were charged in a separation flask of 1 liter provided with a stirrer, a thermometer, a reflux condenser, a dropping funnel, and a gas inlet tube, and 2 g of azobis(4-cyanovaleric acid) as a polymerization initiator was charged in the flask. The mixture was heated to a temperature of 65° C. under a nitrogen gas stream.

Also, 5.0 g of acrylic acid as a carboxylic acid-containing monomer and 95.0 g of methyl acrylate as an alkyl acrylate were mixed, and the resultant mixture was added to the flask from the dropping funnel over 2 hours, kept at constant temperature for 1 hour and then polymerized under reflux for 2 hours to complete the polymerization. As a result, a mixed solution containing a resin component for forming a water-soluble acrylic binder was obtained.

Next, the mixed solution containing the resin component comprising a copolymer was neutralized with ammonia water. Furthermore, 180 g of pure water was added to the mixed solution, and then the mixture was stirred for about 15 minutes to form a water-added solution.

Next, the water-added solution was concentrated according to the following procedure.

First, the water-added solution was concentrated by heating distillation, and 50 g of pure water was added to the residue when the resin content was 30% by weight. Then, concentration was again performed, and terminated when the resin content was 40% by weight. At this time, the pH of the resulting water-soluble acrylic binder was 7.0 because of neutralization with ammonia water as described above.

Next, the binder of Sample 41 was controlled to pH 6.5 with acetic acid as shown in “pH” of “Binder properties” in Table 12, and the binders of Samples 51, 52 and 53 were controlled to pH of 8.9, 9.0 and 10.1, respectively, with ammonia water. The binders of Samples 42 to 50 were kept at pH 7.0 without pH control.

In order to measure the viscosity of each binder, 250 g of pure water was added for controlling the viscosity to the water-soluble acrylic binder of each of Samples 41 to 53 so that the resin content was 20% by weight. The measurement results of solution viscosity are shown in “Solution viscosity” of “Binder properties” in Table 12.

Next, 100 parts by weight of the prepared ceramic raw material powder, an ammonium polyacrylate dispersant (Mw: 1,000) in an amount of 0.5 part by weight in terms of resin component, each of the water-soluble acrylic binders (Mw of the resin component: 200,000) in an amount of 7 parts by weight in terms of resin component, each water-soluble acrylic binder having the above-described pH and a resin content of 40% by weight, 2 parts by weight of ethylene glycol as a plasticizer, and a total of 70 parts by weight of pure water were charged in a ball mill together with 650 parts by weight of zirconia balls of 5 mm in diameter. Then, the mixture was mixed for 20 hours in a wet manner to form a ceramic slurry composition of each of Samples 41 to 53.

Next, as shown in “Presence of pH control” of “Slurry properties” in Table 12, the pH values of the ceramic slurry compositions of Samples 42 to 44, 46 to 50 and 52 were controlled with ammonia water or acetic acid. On the other hand, as shown in “Presence of pH control”, the pH values of the ceramic slurry compositions of Samples 41, 45, 51 and 53 were not controlled. The pH value of each sample subjected to pH control or maintained at its pH value is shown in “pH” of “Slurry properties” in Table 12.

Next, the ceramic slurry composition of each sample was evaluated with respect to the viscosity, viscosity change with passage of time, and particle size distribution represented by “D₅₀” and “D₉₀” shown in “Slurry properties” in Table 12. Since the ceramic slurry compositions of Samples 42 and 43 were gelled, they were not evaluated with respect to the viscosity, viscosity change with passage of time, and particle size distribution. The ceramic slurry compositions of Samples 42 and 43, and the ceramic slurry composition of Samples 50 and 53 which showed a change in viscosity with passage of time were not subjected to the operation below.

Next, the ceramic slurry composition of each of Samples 41, 44 to 49, 51 and 52 was formed into a ceramic green sheet of 60 μm in thickness by a doctor blade method. The thus-formed ceramic green sheet was dried at 80° C. for 5 minutes.

The ceramic green sheet of each of Samples 41, 44 to 49, 51 and 52 was evaluated with respect to molding strength, tensile strength, and elongation percentage shown in “Green sheet properties” in Table 12 by the same method as those used in Experimental Example 1.

TABLE 12

| | | Sample No. | | | | | | | | | | | | |
|---|---|---|---|---|---|---|---|---|---|---|---|---|---|---|
| | | 41 | 42 | 43 | 44 | 45 | 46 | 47 | 48 | 49 | 50 | 51 | 52 | 53 |
| Binder | pH | 6.5 | 7.0 | | | | | | | | | 8.9 | 9.0 | 10.1 |
| proper- | Solution | 5300 | 8 | | | | | | | | | 40 | 45 | 19500 |
| ties | viscosity | x | ∘ | | | | | | | | | ∘ | ∘ | x |
| | (mPa · s) | | | | | | | | | | | | | |
| | (at 20% by | | | | | | | | | | | | | |
| | weight) | | | | | | | | | | | | | |
| Slurry | Presence | Absent | Present | Present | Present | Absent | Present | Present | Present | Present | Present | Absent | Present | Absent |
| proper- | of pH | | | | | | | | | | | | | |
| ties | control | | | | | | | | | | | | | |
| | pH | 8.2 | 5.1 | 7.2 | 8.5 | 8.6 | 8.7 | 9.4 | 9.7 | 10.0 | 10.5 | 9.8 | 9.7 | 11.5 |
| | Viscosity | 120 | (gel) | (gel) | 12 | 11 | 11 | 12 | 13 | 15 | 15 | 12 | 14 | 54 |
| | (mPa · s) | Δ | x | x | ∘ | ∘ | ∘ | ∘ | ∘ | ∘ | ∘ | ∘ | ∘ | Δ |
| | Change in | Absent | — | — | Absent | Absent | Absent | Absent | Absent | Absent | Present | Absent | Absent | Present |
| | viscosity | | | | | | | | | | | | | |
| | with passage | | | | | | | | | | | | | |
| | of time | | | | | | | | | | | | | |
| | Particle | | | | | | | | | | | | | |
| | size | | | | | | | | | | | | | |
| | distribution | | | | | | | | | | | | | |
| | (μm) | | | | | | | | | | | | | |
| | D₅₀ | 0.59 | — | — | 0.51 | 0.50 | 0.50 | 0.49 | 0.50 | 0.49 | 0.50 | 0.50 | 0.50 | 0.54 |
| | D₉₀ | 1.12 | — | — | 0.90 | 0.89 | 0.92 | 0.92 | 0.86 | 0.90 | 0.88 | 0.87 | 0.90 | 1.00 |
| Green | Molding | 3.3 | — | — | 3.6 | 3.5 | 3.6 | 3.6 | 3.6 | 3.5 | — | 3.5 | 3.4 | — |
| sheet | density | | | | | | | | | | | | | |
| proper- | (g/cm³) | | | | | | | | | | | | | |
| ties | Tensile | 2.3 | — | — | 3.8 | 3.8 | 3.9 | 3.6 | 3.9 | 3.8 | — | 3.4 | 3.7 | — |
| | strength | | | | | | | | | | | | | |
| | (MPa) | | | | | | | | | | | | | |
| | Elongation | 31 | — | — | 20 | 18 | 19 | 21 | 19 | 18 | — | 21 | 17 | — |
| | percentage (%) | | | | | | | | | | | | | |

| | | | | | | | | | | | | | |
|---|---|---|---|---|---|---|---|---|---|---|---|---|---|
| Overall evaluation | x | x | x | ∘ | ∘ | ∘ | ∘ | ∘ | ∘ | x | ∘ | ∘ | x |

Table 12 indicates that with Samples 44 to 49, 51 and 52, the viscosity of the slurry properties can be decreased and a change in viscosity with passage of time can be substantially removed because the pH of the binder properties is controlled to about 7 to 9, and the pH of the slurry properties is further controlled to about 8.5 to 10.

On the other hand, with Samples 41 and 53 in which the pH of the binder properties is beyond the range of about 7 to 9, the solution viscosity of the binder properties is significantly increased. Therefore, the viscosity of the slurry properties cannot be decreased and a change in viscosity with passage of time of the slurry properties cannot be suppressed.

Also, with Samples 42 and 43 in which the pH of the slurry properties is beyond the range of about 8.5 to 10 while the pH of the binder properties is in the range of about 7 to 9, the slurry composition gelled and fail to decrease the viscosity of the ceramic slurry composition, as shown in “Viscosity” of “Slurry properties”. Similarly, with Sample 50, a change in viscosity with passage of time cannot be suppressed, as shown in “Viscosity change with passage of time” of “Slurry properties”.

### EXPERIMENTAL EXAMPLE 3

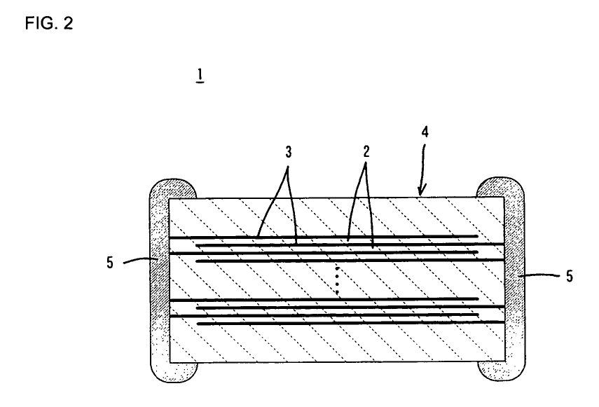

In Experimental Example 3, a monolithic ceramic capacitor 1 having the structure shown in FIG. 2 was formed as a monolithic ceramic electronic part by using one of the ceramic slurry compositions produced in Experimental Examples 1 and 2 in the scope of the present invention.

A ceramic green sheet of about 10 μm in thickness was formed by a doctor blade method using the ceramic slurry composition of the present invention, and then dried at a temperature of 80° C. for 5 minutes. The ceramic green sheet was used as a dielectric ceramic layer 2 shown in FIG. 2.

Next, conductive paste was printed on a main surface of the specified ceramic green sheet to form a conductive paste film. Then, the conductive paste film was dried at a temperature of 80° C. for 10 minutes. The conductive paste was used as a conductive film, i.e., an internal electrode 3 shown in FIG. 2.

Next, 200 ceramic green sheets each having the conductive paste film formed thereon were laminated, and 10 ceramic green sheets without the conductive paste film were laminated at each of the top and bottom of the laminated product to form a ceramic green laminate.

Next, the ceramic green laminate was heat-pressed at a temperature of 80° C. under a pressure of 1000 kg/cm².

Then, the ceramic green laminate was cut into a plurality of ceramic laminate chips so that the size after burning was 3.2 mm in length×1.6 mm in width×1.6 mm in thickness. Each of the ceramic laminate chips was used as a capacitor body 4 shown in FIG. 2.

Next, the plurality of the ceramic laminate chips was burned at a maximum temperature of 1300° C. for about 20 hours to form sintered ceramic laminate chips each used as the capacitor body 4 shown in FIG. 2.

Next, external electrodes 5 were formed on both ends of the capacitor body 4 to complete the monolithic ceramic capacitor 1. The embodiments described above were solely for the purpose of facilitating understanding of the invention and were not intended to be limiting. Various changes and modifications can be made to the invention by those skilled in this art without departing from the spirit and scope thereof.

What is claimed is:

1. A water-soluble acrylic binder comprising an acrylic resin component and a solvent therefor,
wherein the acrylic resin component has a weight average molecular weight of about 10,000 to 500,000 and an inertial square radius in water of about 100 nm or less, and
the alcohol content of the water-soluble acrylic binder is about 5% by weight or less when the resin content is 40% by weight.

2. A water-soluble acrylic binder according to claim 1, having a pH of about 7 to 9.

3. A water-soluble acrylic binder according to claim 2,
wherein the resin component is a polymer of an alkyl (meth)acrylate and a carboxylic acid-containing unsaturated monomerresinresin.

4. A water-soluble acrylic binder according to claim 3,
wherein the acrylic component polymer comprises about 93-99% by weight alkyl (meth)acrylate and about 1-7% by weight carboxylic acid-containing unsaturated monomer.

5. A water-soluble acrylic binder according to claim 4, wherein the alcohol content of the binder is ≦190e^{-0.09X} in which X is 25 to 35.

6. A water-soluble acrylic binder according to claim 1, wherein the acrylic component is a polymer of an alkyl (meth)acrylate and a carboxylic acid-containing unsaturated monomer.

7. A water-soluble acrylic binder according to claim 6, wherein the acrylic component polymer comprises about 93-99% by weight alkyl (meth)acrylate and about 1-7% by weight carboxylic acid-containing unsaturated monomer.

8. A water-soluble acrylic binder according to claim 1, wherein the alcohol content of the binder is ≦190e^{-0.09X} in which X is 25 to 35.

9. A ceramic slurry composition comprising a mixture of a ceramic raw material powder, a water-soluble acrylic binder according to claim 1 , and water.

10. A ceramic slurry composition according to claim 9, wherein the solution viscosity of the water-soluble acrylic binder is about 50 to 50,000 mPa·s when the resin content of the water-soluble acrylic binder is 40% by weight.

11. A ceramic slurry composition according to claim 9, having a pH of about 8.5 to 10.

12. A monolithic ceramic electronic part comprising a baked ceramic slurry composition according to claim 9.

13. A method for producing a water-soluble acrylic binder comprising an acrylic component which is a polymer of an alkyl (meth)acrylate and at least one carboxylic acid-containing unsaturated monomer, the method comprising:
providing a mixed solution containing said acrylic component, water and alcohol;
adding water to the mixed solution to produce a water-added solution; and
concentrating the water-added solution to a resin content X (% by weight) of 25≦X≦35, adding water to the concentrated solution and then concentrating the solution again until Y≦190e^{-0.09X} wherein Y is the alcohol content (% by weight) and X satisfies 25≦X≦35).

14. A method for producing a water-soluble acrylic binder according to claim 13, wherein the amount C (g) of the water added between the two concentration procedures is such to satisfy the relationship 190e-^{-0.09X}/100+0.033≧(A+B/100)/(A+C), wherein A is the total amount (g) of the water-added solution at the time of addition of water, and B is the measured alcohol content (% by weight) of the water-added solution at the time of addition of water.

15. A method for producing a water-soluble acrylic binder according to claim 14, wherein in the concentration procedures, the water-soluble acrylic binder is controlled to a pH of about 7 to 9.

16. A method for producing a ceramic slurry composition comprising mixing a water-soluble acrylic binder according to claim 1, a ceramic raw material powder, and water to produce the ceramic slurry composition.

17. A method for producing a ceramic slurry composition according to claim 16, wherein the ceramic slurry composition is controlled to a pH of about 8.5 to 10.

19. A method for manufacturing a monolithic ceramic electronic part comprising the steps of:
preparing ceramic green sheets comprising a ceramic slurry composition according to claim 9;
forming a conductor film on each of the ceramic green sheets;
laminating and compacting the ceramic green sheets to produce a ceramic laminate; and
burning the ceramic laminate.
